(19) United States
(12) Patent Application Publication
(10) Pub. No.: US 2006/0193303 A1
(43) Pub. Date: Aug. 31, 2006

(54) Radio network controller

(76) Inventors: Junko Sato, Fukuoka (JP); Masanobu Shigyo, Fukuoka (JP); Shinji Ohisi, Fukuoka (JP); Yuichiro Oishi, Fukuoka (JP); Tatsuhiko Takata, Fukuoka (JP)

Correspondence Address: KATTEN MUCHIN ROSENMAN LLP, 575 MADISON AVENUE, NEW YORK, NY, 10022-2585, US

(21) Appl. No.: 11/410,374

(22) Filed: Apr. 25, 2006

Related U.S. Application Data
(63) Continuation of application No. PCT/JP03/17081, filed on Dec. 26, 2003.

(51) Int. Cl. H04L 12/28; H04J 1/16; H04L 12/26; H04L 12/56; H04Q 7/24

(52) U.S. Cl. 370/338; 370/401; 370/389; 370/241

(57) ABSTRACT

A radio network controller disposed on a network, for implementing effective use of bands in use considering the characteristics of the use form of the users, not by physical expansion, the radio network controller having a user resource management section for managing information for characterizing a user connected to the radio network controller, a plurality of user signal data conversion sections for performing conversion processing of the user signal data respectively, and a resource control section for performing resource control for securing bands for the plurality of user signal data conversion sections, wherein the resource control section secures a band appropriate for the characteristics of the user by controlling the shift of calls among the plurality of user signal data conversion sections.

### CROSS REFERENCE TO RELATED APPLICATIONS

This application is a continuation of International Application No. PCT/JP2003/017081, filed on Dec. 26, 2003, now pending, herein incorporated by reference.

### TECHNICAL FIELD

The present invention relates to a radio network controller (RNC) on a W-CDMA (Wideband-Code Division Multiple Access) network.

### BACKGROUND ART

The mobile network of W-CDMA comprises a mobile station (MS), base transceiver station (BTS), radio network controller (RNC), radio packet communication nodes (SGSN: Serving GPRS Support Network, GGSN: Gateway GPRS Support Network), and a home location register (HLR), as shown in FIG. 1.

In a mobile network, such as a portable telephone system, the radio network controller RNC controls the radio transceiver station BTS, in other words, has functions corresponding to outgoing/incoming connection control, termination control and diversity handover control.

The radio network controller RNC also has the functions to convert protocols between the core network (CN) side and the radio block (RAN) side, and generate user signals (U-Plane) optimum for each block.

FIG. 2 shows an example of the configuration of the radio network controller RNC in a prior art.

A Third Generation Partnership (hereafter 3GPP) recommendation standardizes the channel switching of a packet call according to the change of traffic, in order to transfer data in radio blocks efficiently, where a band required for each channel type is secured in the radio network controller RNC.

Out of the channel types defined in W-CDMA, channels that the user transits at packet connection are as follows.

DCH (Discrete CH): data transfer status from a certain band to the highest band

FACH/RACH (common CH): data transfer status from a certain band to the lowest band

PCH (Paging CH): no communication (no data transfer) status

In the radio network controller RNC, channel switching control conforming to this recommendation is performed. In addition to this, required bands according to each channel type are secured.

Channels are switched when the transfer volume of the user data is increased/decreased, since the required band increases as the data transfer volume increases.

As FIG. 2 shows, in the radio network controller RNC, a plurality of user signal (U-Plane) data conversion sections 100 provide redundancy to increase reliability, and implement band management and protocol conversion. A call accommodated in a U-Plane data conversion section 100 is accommodated and managed in the same U-Plane data conversion section until the call is disconnected.

In addition to the above mentioned three channels, DSCH (Downlink Shared CH) has recently been standardized by 3GPP as a channel in downlink high-speed data transfer status, which exceeds the current highest band. This is a channel to implement a new communication system called HSDPA (High-Speed Downlink Packet Access), and HSDPA is a communication system which enables high-speed communication of which the downlink speed is 10 and several Mbps or higher.

As mentioned above, channels for packet calls are normally switched when the transfer volume of the user data is increased/decreased, and channels are switched to be appropriate for the data transfer volume of each user. And in the internal configuration of the device of the radio network control RNC, a plurality of U-Plane data conversion sections 100 for converting the user data are generally installed to provide redundancy to improve reliability of the system.

However, the number of channels (number of users) that can be set in each U-Plane data conversion section 100 and the bands that can be secured in each of the U-Plane data conversion section 100 are both limited.

In the future, an expansion of the highest band of packet calls (HSDPA) is scheduled, and new service formats, such as constant connection, will be added as this is implemented.

However, users who use this service format are not constantly in communication, so it is quite likely that users in no communication status (PCH), who are connected but are not performing data transfer, will increase in the future. In this case, the following problems occur in the prior art.

First, while the data transfer volume used by the user increases, the required maximum band cannot be secured, and delays occur to the data transfer.

FIG. 3 is a diagram depicting this first problem, where the status of the resource of the U-Plane data conversion section 100 is shown. As FIG. 3A shows, when the discrete channels Dch and the common channels Cch are in use, if the use of a resource which requires a predetermined band width is requested, and if the maximum resource MAX is exceeded as shown in FIG. 3B, then the requested predetermined band width cannot be secured.

In this case, the data is divided and transferred, which generates a delay.

A second problem is that the use of bands by a new user is limited due to the restriction on the number of users which is set to handle the increase in the number of users, even though there are more than enough bands to be secured in the U-Plane data conversion section 100.

FIG. 4 is a diagram depicting this second problem. In FIG. 4, when the number of users in non-communication status is high, and the number of resources which are not used, including the non-communication status calls X, is high, and as a consequence the maximum value Max of the resource has already been exceeded, use by a new user is limited.

When the standard to expand the highest band (e.g. HSDPA) is introduced in the future, a radical change (increase) of data transfer volume to be used by users, as shown by the first problem, and a rapid increase of packet exchange users in non-communication status accommodated by the device, as shown by the second problem, are expected. Therefore the above mentioned problems will be conspicuous.

A method to solve these problems is securing sufficient bands by physically increasing the U-Plane data conversion section 100 or adding radio network controllers RNCs. This method, however, is not effective in terms of cost, and therefore is not a practical solution.

A known prior art related to the above issue is a technology on the management of packet exchange connection in a communication network (Japanese Patent Publication No. 3390743). In this prior art, when a resource is insufficient, the communication connection of the service node (SGSN) and the radio network subsystem (RNC) are cleared or reconnected according to the idle status (Japanese Patent Publication No. 3390743).

Also there is a technology to prevent a drop in communication speed using channels effectively when traffic is high in packet type car telephones (Japanese Patent Application Laid-Open No. H8-33034).

In the technologies disclosed in the above documents, however, the number of channels (number of users) that can be set in the U-Plane data conversion section 100 and the bands that can be secured in each U-Plane data conversion section 100 are both limited, and an expansion of the highest band of packet calls (HSDPA) scheduled in the future and the addition of a new service format, such as constant connection, which would be provided accordingly, are not considered.

### DISCLOSURE OF THE INVENTION

With the foregoing in view, it is an object of the present invention to provide a radio network controller RNC for handling a radical change (increase) of the data transfer volume used by a user, and a rapid increase of packet exchange users in non-communication status accommodated by the device, by effectively using the bands in use considering characteristics of the user, such as use format, and not by physical expansion.

A first aspect of the radio network controller RNC to achieve the above object of the present invention is a radio network controller disposed on a network, comprising: a user resource management section for managing information for characterizing a user connected to the radio network controller; a plurality of user signal data conversion sections for performing conversion processing of user signal data respectively; and a resource control section for performing resource control for securing bands for the plurality of user signal data conversion sections, wherein the resource control section secures a band appropriate for the characteristics of the user by controlling the shift of calls between the plurality of user signal data conversion sections.

A second aspect of the radio network controller RNC to achieve the above object of the present invention is the first aspect, further comprising a traffic statistical section for performing traffic collection for extracting the characteristics of each user, and a user information management data base for storing the characteristics of each user collected by the traffic statistical section according to the control of the user resource management section, wherein the user resource management section requests the resource control section to secure bands corresponding to the characteristics of each user stored in the user information management data base.

A third aspect of the radio network controller RNC to achieve the above object of the present invention is the second aspect, wherein the traffic statistical section further includes position statistical unit for tabulating a position-based traffic statistics of each user, and stores the position-based traffic statistics for each user tabulated by the position statistical unit, in the user information management data base, and the user resource management section secures bands by requesting the resource control section to secure bands according to the tabulated position-based traffic for each user, stored in the user information management data base.

A fourth aspect of the radio network controller RNC to achieve the above object of the present invention is the second aspect, wherein the traffic statistical section further includes time statistical unit for tabulating the time-based traffic statistics of each user, and stores the time-based traffic statistics tabulated by the time statistical unit, in the user information management data base, and the user resource management section secures bands appropriate for the tabulated time-based traffic for each user stored in the user information management data base.

A fifth aspect of the radio network controller RNC to achieve the above object of the present invention is one of the first to third aspects, wherein the user resource management section calculates a required band according to the use status of each user stored in the user information management data base, and requests the resource control section to secure the calculated required band.

A sixth aspect of the radio network controller RNC to achieve the above object of the present invention is the fifth aspect, wherein when the control of securing a band requested from the user resource management section to the resource control section is performed, if a corresponding user signal data conversion section cannot secure a band, control is performed such that another user signal data conversation section secures bands.

A seventh aspect of the radio network controller RNC to achieve the above object of the present invention is the sixth aspect, wherein a judgment count threshold is attached to a band securing request from the user resource management section to the resource control section, and the resource control section receives a traffic report from the user signal data conversion section at a predetermined cycle, compares a band which can maintain the current traffic and a band which is currently secured each time a traffic report is received, and performs control to change the band which is currently secured to the band which can maintain the current traffic, when the number of successive judgments that the band which can maintain the current traffic is smaller is the judgment count threshold or more as the comparison result.

An eighth aspect of the radio network controller RNC to achieve the above object of the present invention is the first aspect, wherein when the user shifts to non-communication status, the resource control section performs control such that the non-communication status calls are distributed to a plurality of user signal data conversion sections so that the number of calls become equal, based on the use status of the non-communication status users accommodated in all of the plurality of user signal data conversion sections.

A ninth aspect of the radio network controller RNC to achieve the above object of the present invention is one of the first to second and fifth to seventh aspects, wherein the user resource management section further includes position statistical management unit, and estimates the increase/decrease of position-based traffic from the position-based traffic of each user stored in the user information management data base, and the resource control section performs control such that the band according to the traffic of the shift destination of the user is secured in the user signal data conversion section.

A tenth aspect of the radio network controller RNC to achieve the above object of the present invention is one of the first to second and fifth to seventh aspects, wherein the user resource management section further includes time statistical management unit and estimates the increase/decrease of time-based traffic from the time-based traffic of each user stored in the user information management data base, and the resource control section performs control such that the band according to the time-based traffic of each user is secured in the user signal data conversion section.

An eleventh aspect of the radio network controller RNC to achieve the above object of the present invention is one of the first to second and fifth to seventh aspects, wherein the user resource management section further includes user contract information management unit, and estimates a required band according to the contract contents of each user stored in the user information management data base, and the resource control section performs control such that the required band according to the contract contents of each user is secured in the user signal data conversion section.

The characteristics of the present invention shall be further clarified by the embodiments of the present invention to be described below with reference to the drawings.

### BRIEF DESCRIPTION OF THE DRAWINGS

FIG. 1 is a diagram depicting a configuration example of a mobile network of W-CDMA;

FIG. 2 is a diagram depicting a configuration example of a radio network controller RNC according to a prior art;

FIG. 3 is a diagram depicting the first problem and shows the resource status of the U-Plane data conversion section 100;

FIG. 4 is a diagram depicting the second problem;

FIG. 5 is a block diagram depicting a configuration example of a radio network controller according to the present invention;

FIG. 6 shows a sequence flow of an example of band control based on position-based traffic estimation;

FIG. 7 shows a sequence of band control by time-based traffic estimation, which is the fourth and tenth characteristics, this is a band control sequence based on time-based traffic estimation;

FIG. 8 shows a sequence of band control by contract-based traffic estimation, which is the eleventh characteristic;

FIG. 9 is a diagram depicting the implementation of securing a band by shifting calls;

FIG. 10 is a flow chart depicting the sixth characteristic;

FIG. 11 shows a sequence flow depicting the seventh characteristic;

FIG. 12 is a processing flow depicting the seventh characteristic, this is a flow chart when the band is released;

FIG. 13 is a processing flow depicting the eighth characteristic;

FIG. 14 shows an example of the traffic statistical DB 370;

FIG. 15 shows an example of position-based traffic statistical data;

FIG. 16 shows a correspondence table of the secured resource according to the traffic;

FIG. 17 shows an example of the use ratio and the number of accommodated calls in each user signal data conversion section;

FIG. 18 shows time-based traffic data;

FIG. 19 shows an example of subscriber information;

FIG. 20 is a table showing the bands to be secured for each contract type of user;

FIG. 21 is a flow chart depicting the resource control of the U-Plane resource control section 350 for securing the band based on the contract type of the user or more;

FIG. 22 shows an example of assigning priority to a band control request;

FIG. 23 shows a user traffic report which the U-Plane data conversion section 360 performs for the U-Plane resource control section 350 at a predetermined cycle;

FIG. 24 shows a processing sequence for distributing non-communication status calls; and

FIG. 25 is a diagram depicting the shift of non-communication status calls according to the sequence in FIG. 24.

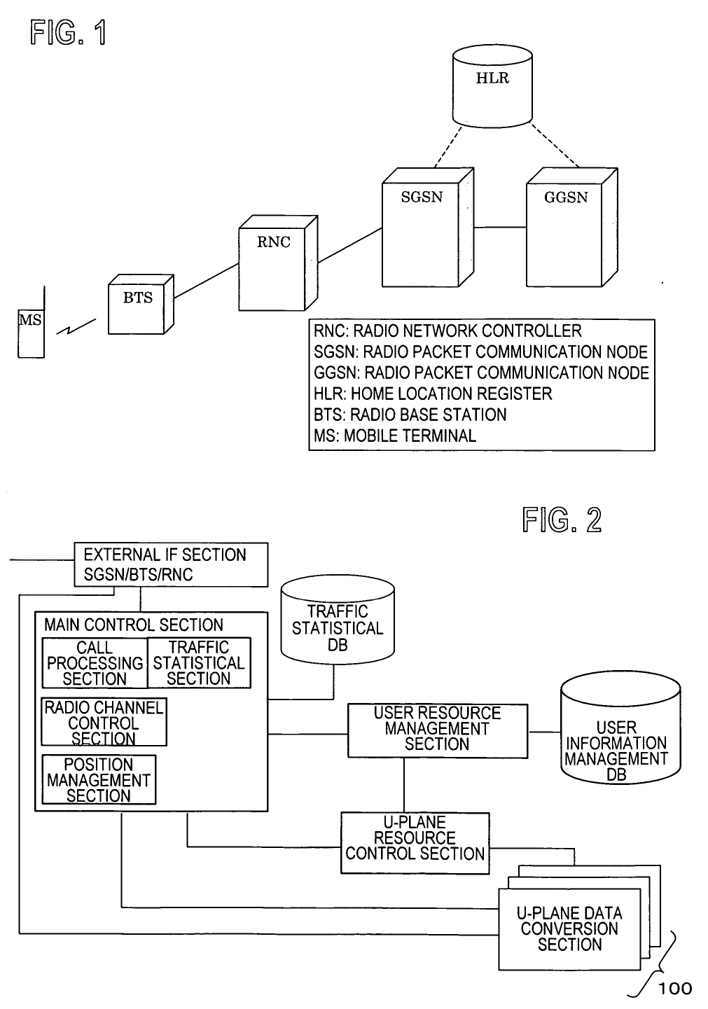

### BEST MODE FOR CARRYING OUT THE INVENTION

Embodiments of the present invention will now be described with reference to the drawings. The embodiments are for assisting understanding the present invention, and application of the present invention shall not be limited to these embodiments.

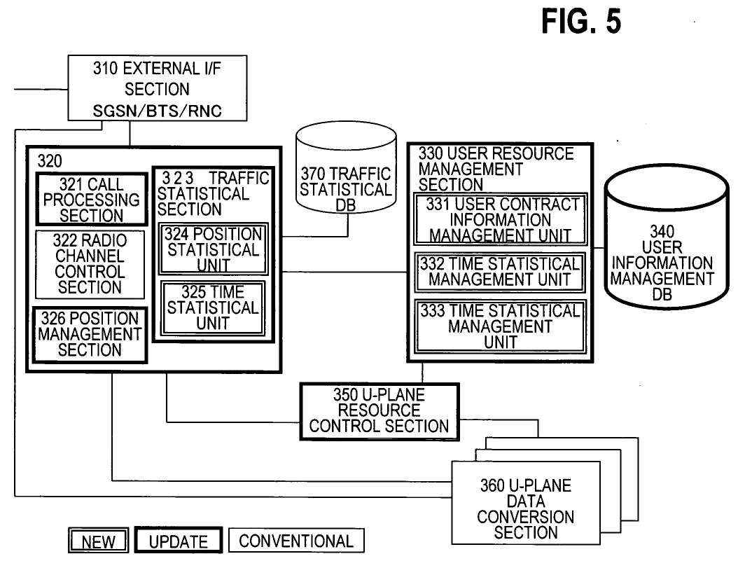

FIG. 5 shows a block diagram depicting a configuration example of the radio network controller RNC according to the present invention. Compared with the configuration of the conventional radio networks controller RNC shown in FIG. 2, a function section newly added according to the present invention is enclosed by a double line frame, and a section having updated functions is enclosed by a bold frame.

Prior to description of the embodiments of the present invention, the function of each functional block constituting the radio network controller RNC, to which the present invention in FIG. 5 is applied, will be briefly described.

1) External IF section 310: transmits/receives messages to/from a remote node, and notifies to each section

2) Main control section 320: control section to play a major function of the radio network controller. The main control section 320 further includes the following functional sections.

Call processing section 321: controls the connection of calls, and notifies subscriber information, which is required as a data for characterizing the user, to the traffic statistical section 323 and user resource management section 330. Also decides the channel type according to the traffic, notifies the resource securing request corresponding to the channel to be switched to the U-Plane resource control section 350, and notifies the channel switching instruction to the radio channel control section 322.

Radio channel control section 322: controls the switching of the channel of a call according to the channel switching instruction from the call control section 321.

Traffic statistical section 323: further includes position statistical unit 324 and time statistical unit 325. Receives traffic report from the U-Plane data conversion section 360, and stores and manages data in the traffic statistical DB 370.

Position statistical unit 324: receives and manages position registration information of the user from the position management section 326 or call processing section 321, and associates the traffic statistical data of the traffic statistical DB 370 and position information. And notifies the associated position-based traffic data to the user resource management section 330.

Time statistical unit 325: associates the traffic statistical data of the traffic statistical DB 370 and current time. And notifies the associated time-based traffic data to the user resource management section 330 at a predetermined cycle.

Position management section 326: receives position registration information notice at a predetermined cycle or when the position registration area changed as the user shifts, and updates the position information. Also manages the position registration information and extracts and notifies the necessary data to the position statistical unit 324.

3) User resource management section 330: receives data which characterizes the use status of the user from the call processing section 321, position statistical unit 324 and time statistical unit 325, and stores and manages it in the user information management DB 340.

User contract information management unit 331: manages the contract information of the subscriber and notifies the band control conditions based on the contract contents to the U-Plane resource control section 350.

Time statistical management unit 332: manages the time-based traffic statistical data of the user information management DB 340, estimates the traffic of the current time according to the traffic statistics from the DB corresponding to the current time of the user, and requests the U-Plane resource control section 350 to secure a resource for this user call.

Position statistical management unit 333: manages the position-based traffic statistical data of the user information management DB 340, receives the current position of the user from the position statistical unit 324, estimates the traffic of the current position according to the traffic statistics of the user information management DB 340 corresponding to the position, and requests to secure a resource for this user call.

4) User information management DB 340: stores user subscriber information, and stores data on the time-based traffic statistics and position-based statistics for each user.

5) U-Plane resource control section 350: controls the resource of the U-Plane data conversion section 360 receiving the request from the call processing section 321, time statistical management unit 332, and position statistical management unit 333. In this case, the resource control conditions for each user are received from the user contract information management unit 331, and a resource is controlled according to the resource control conditions when the above request is received.

When a channel of a call which is already connected is changed, and if the resource cannot be secured in the U-Plane data conversion section 360 in which this call is accommodated, the call is shifted to another U-Plane data conversion section 360.

6) U-Plane data conversion section 360: performs conversion processing of user data. Also periodically reports the traffic report to the traffic statistical section 323.

7) Traffic statistical DB 370: stores the traffic statistics of each user.

Now the characteristics of the present invention based on the configuration of the radio network controller RNC will be described.

[First Characteristic]

The first characteristic is to enable securing a resource according to the position-based traffic estimation of the user.

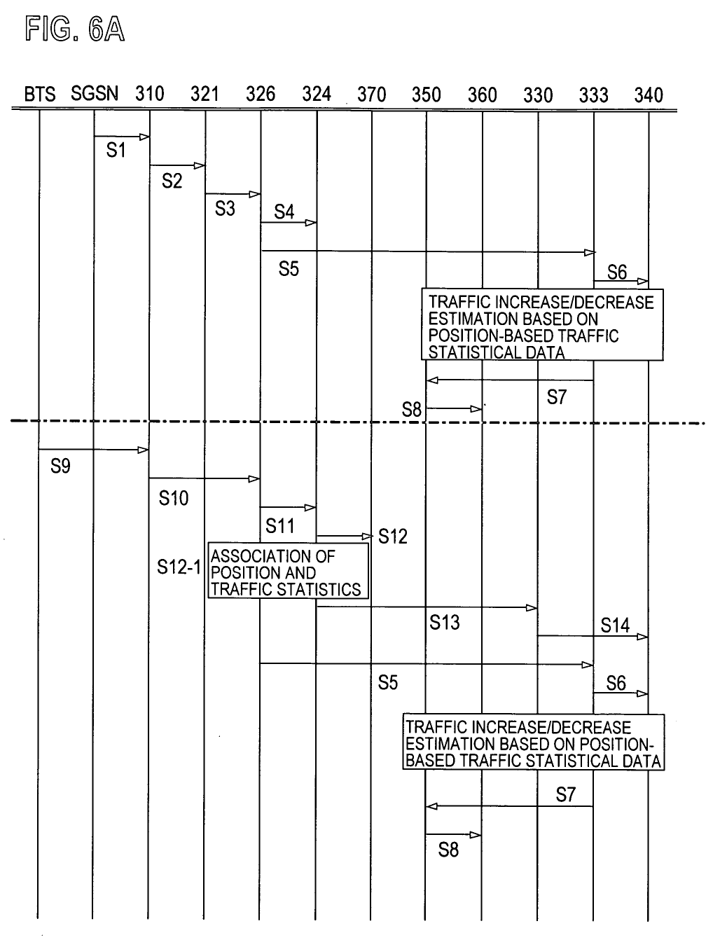

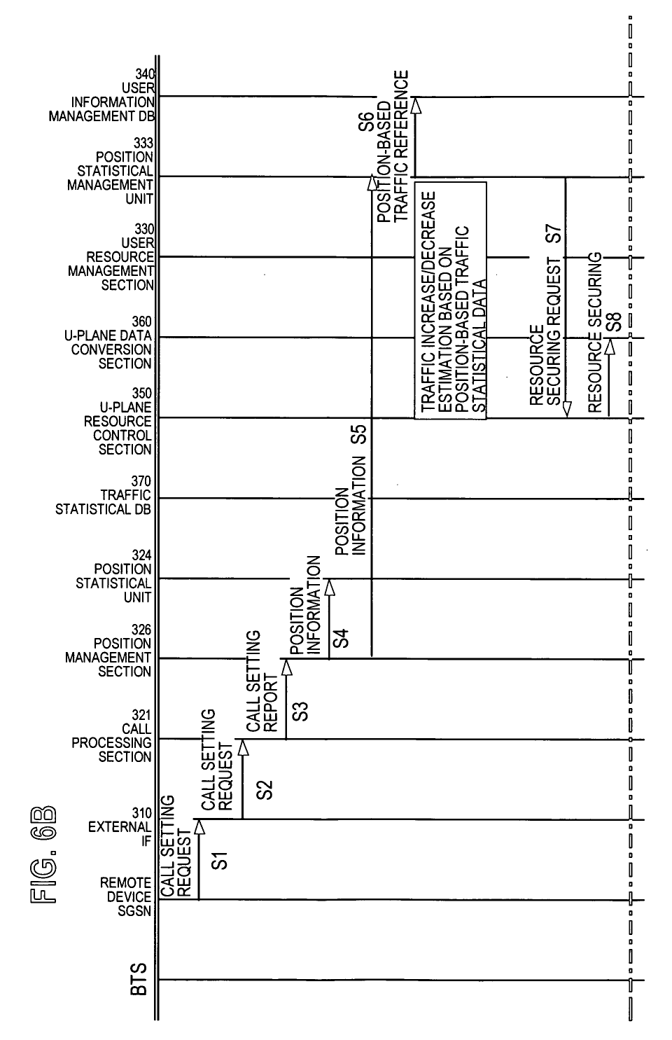

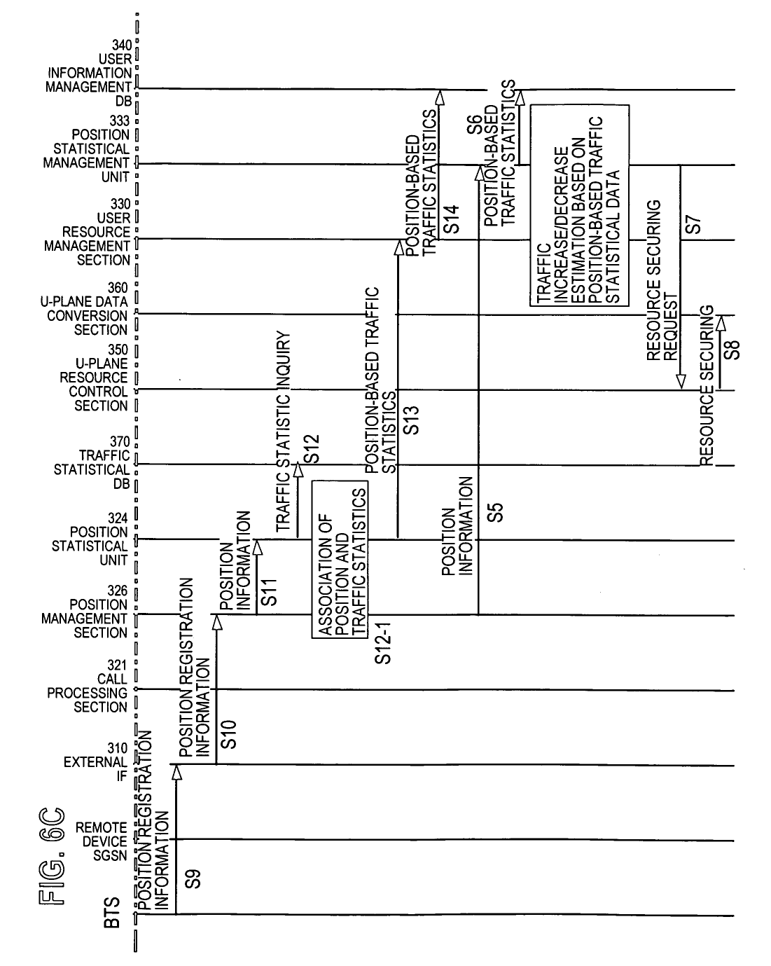

FIG. 6 is a sequence flow depicting an example of band control based on position-based traffic estimation. According to this sequence flow, the operation of the radio network controller RNC in FIG. 5 will be described.

When the radio network controller RNC received a call setting request, including subscriber information, from the remote (node) device by the external interface (IF) section 310 (step S1), the external interface (IF) section 310 notifies the call processing section 321 of the main control section 320 that the message was received (step S2).

The call processing section 321 notifies the position management section 326 that call setting was requested (step S3), the position management section 326 notifies the position information of the user to the position statistical unit 324 of the traffic statistical section 323 (step S4), and also to the position statistical management unit 333 of the user resource management section 330 (step S5).

By this, the position statistical unit 324 starts traffic collection. At this time, the position statistical management unit 333 refers to the user information management DB 340 (step S6), confirms whether there is a tabulated traffic static of the current position, and if the traffic can be estimated from the current position information, the resource securing request according to the statistics is notified to the U-Plane resource control section 350 (step S7).

The U-Plane resource control section 350, which received the request, secures the resource in the U-Plane data conversion section 360 (step S8).

Also the radio network controller RNC receives the position registration information of the user from the external IF section 310 periodically or when the position of the user is changed (step S9). The external IF section 310 notifies the position registration information to the position management section 326 (step S10), and the position management section 326 notifies the position information to the position statistical unit 324 (step S11).

The position statistical unit 324 refers to and tabulates the traffic statistics in the position information before the change in the traffic statistical DB 370 (step S12), and notifies it to the user resource management section 330 (step S13). The user resource management section 330 which received the position-based traffic statistics stores the data in the user information management DB 340 (step S14).

Processing there after is the same as the case when the call setting request is sent (steps S5-S8).

As described above, the position-based traffic of the user is stored in the user information management DB 340 whenever necessary, so a resource in the U-Plane data conversion section 360 according to the position-based traffic estimation of the user can be secured.

[Second Characteristic]

The second characteristics is to enable securing a resource according to the time-based traffic estimation of the user.

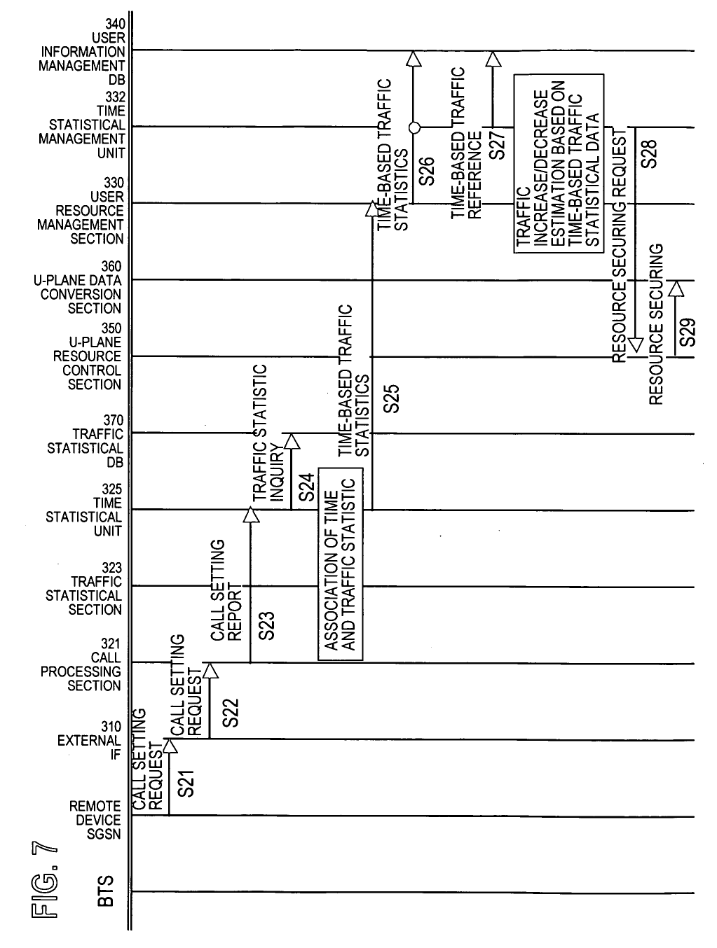

FIG. 7 is a sequence flow depicting the band control based on time-based traffic estimation, which is the second characteristic. The device configuration of the radio network controller RNC is the same as that in FIG. 5.

When the radio network controller RNC received a call setting request, including subscriber information, from the remote node SGSN (step S21), the external IF section 310 notifies the call processing section 321 that the message was received (step S22).

The call processing section 321 notifies the time statistical unit 325 that call setting was performed (step S23), and the time statistical unit 325 starts collecting time-based traffic.

The time statistical unit 325 also refers to the traffic statistical DB 370 at a predetermined cycle during call connection (step S24), refers and tabulates time-based traffic statistics, and notifies the time-based traffic statistics to the user resource management section 330 (step S25). Therefore the user resource management section 330 stores the notified time-based traffic statistics to the user information management DB 340 (step S26).

The time statistics management unit 332 refers to the user information management DB 340 at a predetermined cycle (step S27), and if traffic can be estimated from the current time, the resource securing request according to the time-based traffic statistics is notified to the U-Plane resource control section 350 (step S28). The U-Plane resource control section 350 which received the request secures the resource in the U-Plane data conversion section 360 (step S29).

Just like the estimation by position-based traffic statistics shown in FIG. 6, if traffic statistics at this time already exist in the past in the user resource management section 330 at call setting, time-based traffic is also estimated at this call setting.

By storing the time-based traffic of the user in the user information management DB 340 whenever necessary in this way, a resource in the U-Plane data conversion section 360 according to the time-based traffic estimation of the user can be secured.

[Third Characteristic]

The third characteristic is to enable securing the resource according to the contract contents of the user.

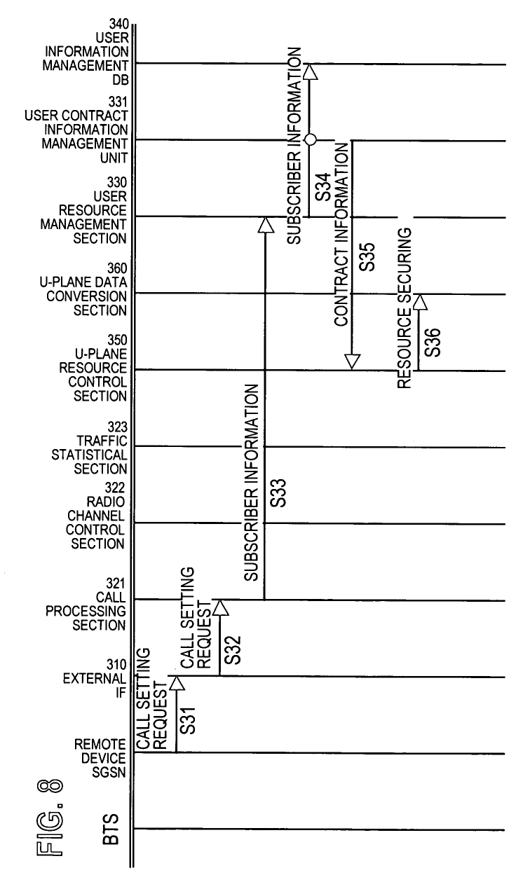

FIG. 8 is a sequence depicting the band control based on the contract-based traffic, which is the third characteristic. Here too the device configuration of the radio network controller RNC is the same as that shown in FIG. 5.

When the radio network controller RNC received a call setting request, including the subscriber information, from the remote node (step S31), the external IF section 310 notifies the call processing section 321 that the message was received (step S32). The call processing section 321 extracts the necessary subscriber information out of the call setting request, and notifies the subscriber information to the user resource management section 330 (step S33).

The user resource management 330 stores the notified data to the user information management DB 340 (step S34).

The user contract information management unit 331 notifies the resource securing request according to the conditions of the contract contents of the user to the U-Plane resource control section 350 (step S35). The U-Plane resource control section 350 which received the request secures the resource of the U-Plane data conversion section 360 according to the request (step S36).

By storing the contract information of the user in the user information management DB 340, the resource of the U-Plane data conversion section 360, according to the contract contents of the user, can be secured.

[Fourth Characteristic]

The fourth characteristic is to expand the bands to be secured by securing a band in a U-Plane data conversion section 360 that can secure the band.

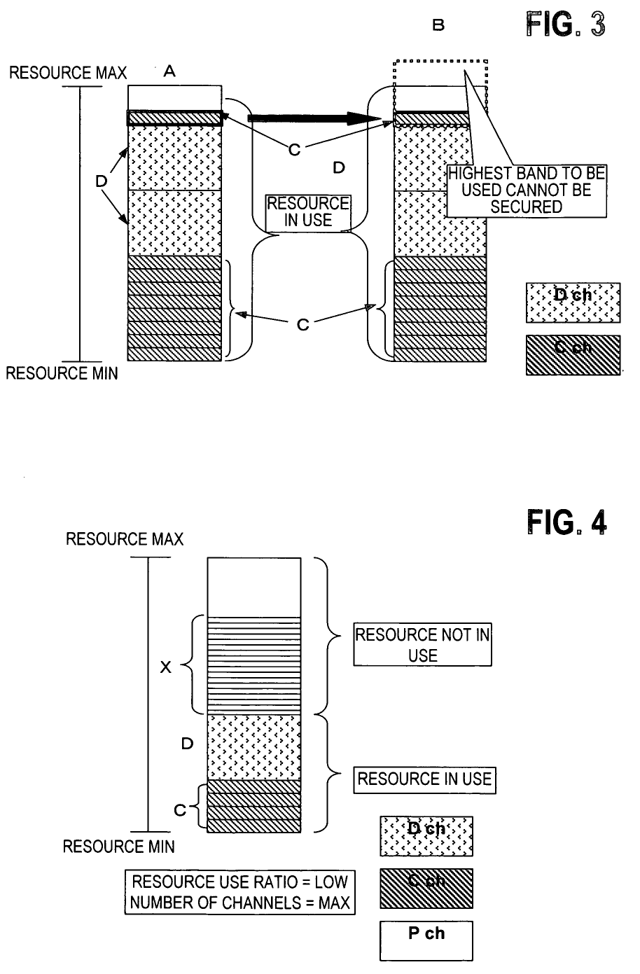

If bands to be secured are expanded by shifting a channel when traffic is increased or by estimation, the bands required by the call may become insufficient in the U-Plane data conversion section 360 for accommodating calls, as described in FIG. 3.

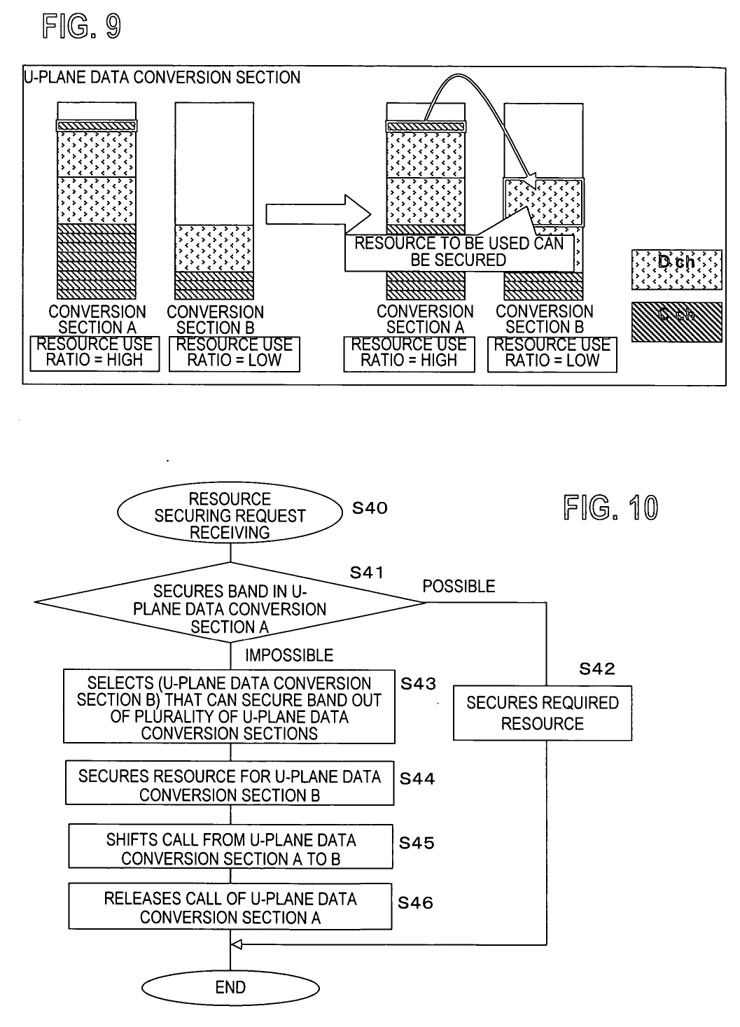

In this case, the U-Plane resource control section 350 searches another U-Plane data conversion section 360 that can secure the band required by the call out of a plurality of U-Plane data conversion sections, as shown in FIG. 9, and the band is secured in the U-Plane data conversion section 360 that can secure the band, and this call is shifted there, then the required band can be secured.

FIG. 10 is a processing flow depicting the fourth characteristic. As FIG. 9 shows, two U-Plane data conversion sections A and B are considered as the U-Plane data conversion sections 360. The U-Plane data conversion section A is the case when the resource use ratio is high, and the other U-Plane data conversion section B is the case when the resource use ratio is low.

When a resource securing request is received (step S40), it is judged whether the band can be secured in the first U-Plane data conversion section A (step S41). If the band can be secured (step S41, possible), the band is secured simply in the U-Plane data conversion section A (step S42).

If the band cannot be secured (step S41, impossible), the U-Plane data conversion B is selected from the plurality of U-Plane data conversion sections (step S43). And the band is secured in the selected U-Plane data conversion section B (step S44).

Then the call is shifted from the U-Plane data conversion section A to the U-Plane data conversion section B in which the band is secured (step S45), and the call of the U-Plane data conversion section A is released (step S46).

[Fifth Characteristic]

The fifth characteristic is to enable adjusting the timing to release the band according to the characteristic of the user.

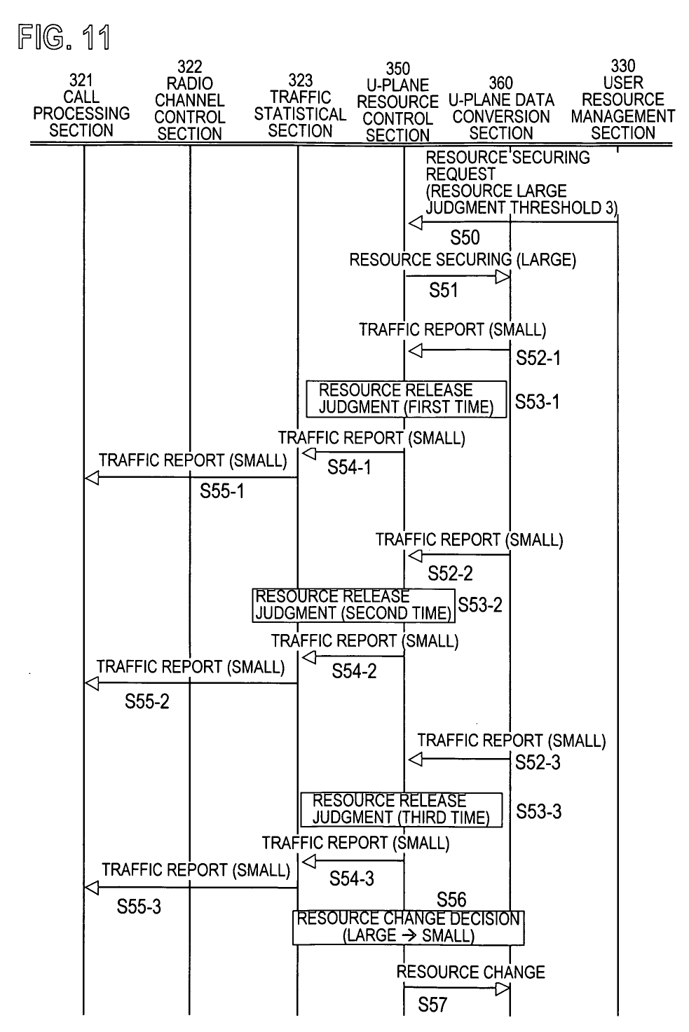

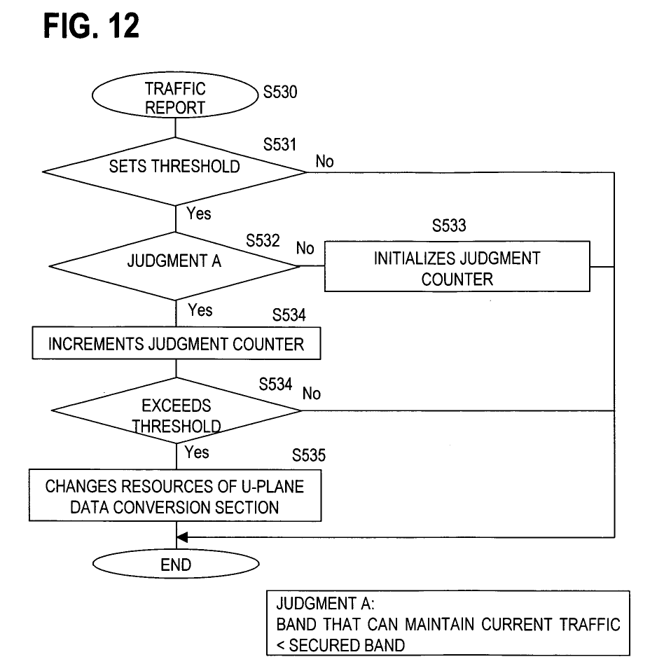

FIG. 11 and FIG. 12 are the sequence flow and processing flow depicting the fifth characteristic respectively. The device configuration of the radio network controller RNC is the same as that shown in FIG. 5.

The U-Plane resource control section 350 receives the resource securing request based on traffic estimation (request to expand resource) from the user resource management section 330 (step S50). At this time, the user resource management section 330 refers to the user management information DB 340, and notifies the judgment threshold to maintain the requested band as additional information.

The U-Plane resource control section 350 secures the requested band (step S51), then receives a traffic report from the U-Plane data conversion section 360 at a predetermined cycle (steps S52-1-S52-3). In the example in FIG. 11, the band to be used is smaller than the estimated band.

Based on this traffic report, the U-Plane resource control section 350 judges whether a resource is released each time the report is received (steps S53-1-S53-3).

This resource release judgment procedure is as shown in FIG. 12. In FIG. 12, when the traffic report is received from the U-Plane data conversion section 360 (step S530), it is judged whether the threshold setting exists (step S531).

If the threshold setting exists (steps S531, YES), the band which can maintain the current traffic and the secured band are compared (step S532). In this comparison, if the band that can maintain the current traffic is larger than the secured band (step S532, NO), the judgment counter is initialized (step S533). And in FIG. 11, the traffic report is notified from the U-Plane data conversion section 360 to the traffic statistical section 323 (steps S54-1-S54-3), and is then notified from the traffic statistical section 323 to the call processing section 321 (steps S55-1-S55-3).

If it is judged that the band that can maintain the current traffic is smaller than the secured band in the comparison judgment step S532 in FIG. 12 (step S532, YES), the judgment counter is incremented (step S533).

The count value of the judgment counter and the threshold setting value to be attached to the resource securing request are compared (step S534). When the count value of the judgment counter exceeds the threshold setting value (step S534), the change of the resource in the U-Plane data conversion section 360 is determined (step S535, FIG. 11: step S56).

Therefore in FIG. 11, a change to decrease bands, from the band secured based on an estimate to the band that can maintain current traffic, is instructed to the U-Plane data conversion section 360 (step S57).

The call processing section 321 switches channels corresponding to the traffic report, and notifies the resource securing request to the U-Plant resource control section 350, but if the requested band is larger than the secured band (step S532, NO), the U-Plane resource control section 350 secures the resource as requested from the call processing section 321, and if the secured band is larger (step S532, YES), on the other hand, priority is assigned to the threshold.

As described above, by setting the judgment threshold according to the characteristics of each user, the timing to release the band can be adjusted according to the characteristics of the user.

[Sixth Characteristic]

The sixth characteristic is to enable avoiding the number of channels being restricted by the cluster of non-communication status user calls.

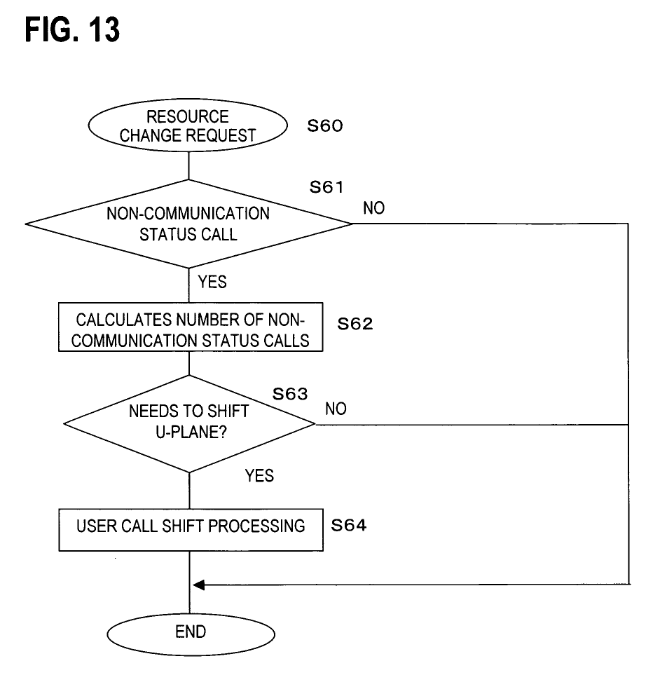

FIG. 13 is a processing flow depicting the sixth characteristic. The device configuration of the radio network controller RNC is the same as that shown in FIG. 5.

When the channel of the user is shifted, the resource securing request from the call processing section 321 (step S60) is received by the U-Plane resource control section 350, and the U-Plane data conversion section 360 secures the band according to the channel status.

In this case, if the user call changes to non-communication status (FIG. 13, step S61, YES), the U-Plane resource control section 350 sends a non-communication status call information collection request to the user resource management section 330 (to collect] the characteristics of the users of all the non-communication status calls accommodated by each U-Plane data conversion section.

The user resource management section 330 refers to the user information management DB 340, and notifies the characteristics of the users to the U-Plane resource control section 350 as the non-communication status call information collection response.

By this, the U-Plane resource control section 350 calculates the number of all the users of non-communication status calls, and acquires the characteristics thereof (step S62).

Based on the acquired characteristics of all the users, it is judged whether a shift is required such that the non-communication status calls, for which high traffic is expected in the future, and other non-communication calls are evenly distributed (step S63).

Based on this judgment, if a shift is necessary (step S63, YES), the U-Plane data conversion section 360 performs user call shift processing (step S64).

By this, the restriction of the number of channels of the U-Plane data conversion sections 360, due to the clustering of non-communication status user calls to a part of the U-Plane data conversion sections 360, can be prevented.

Now the operation of a concrete example according to the present invention having the above characteristics will be described. In the description, the sequences and flow charts used above are referred to when necessary.

[Registration and Estimation of Position-Based Traffic Statistics]

When the user (U1) at a certain position (A1) called in FIG. 6, the radio network controller RNC receives the call setting request, including the subscriber information, from the remote node via the external interface (IF) section 310 (step S1).

The external interface (IF) section 310 notifies the call processing section 321 of the main control section 320 that the call setting request message was received (step S2).

When the call setting request is notified to the call processing section 321, the call processing section 321 performs call setting processing for the user (U1), and also notifies the position management section 326 that call setting processing for the user (U1) was performed, as the call setting report (step S3).

At the point of this notice, the position management section 326 notifies the position statistical unit 324 that the position of the user (U1) who is being managed is at (A1) as the position information (step S4). The position statistical unit 324 manages the position information on existing in (A1) and the time when this information was received (T1: 2003/6/19 20:00) until the position information of the user (U1) will be received next.

The position registration information of the user (U1) is notified periodically or when the position of the user changed (e.g. position changed from A1 to A2) (step S9), and the position registration information received by the external IF section 310 is notified to the position management section 326 (step S10).

The position management section 326 notifies the position information that the user (U1) is existing in A2 and the time when the information was received (T2: 2003/6/19 20:03) to the position statistical unit 324 (step S11). At this timing, the position statistical unit 324 refers to the traffic statistical DB 370 to acquire the traffic statistics at T1-T2 of the user (U1). (step S12).

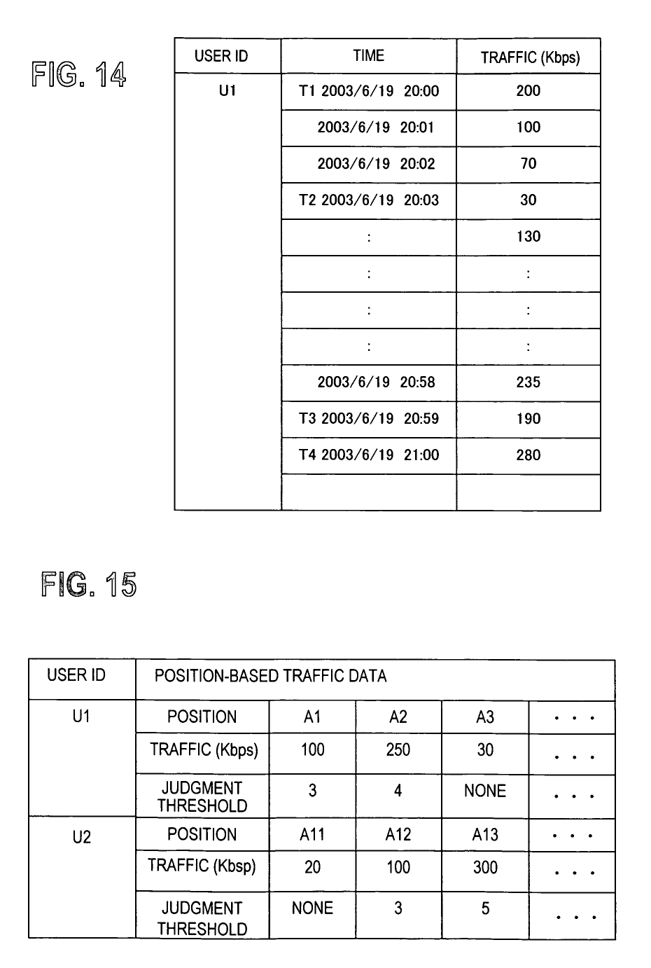

FIG. 14 shows an example of the traffic statistical DB 370. In FIG. 14, traffic data with a one minute interval is used as an example, but this interval is not limited to one minute.

The position statistical unit 324 generates position-based traffic statistical data where the average traffic in time T1-T2 (100 Kbps) for the user (U1) acquired by referring to the traffic statistical DB 370 and the position information (A1) are associated (step S12-1). This generated position-based traffic statistical data is notified to the user resource management section 330 (step S13), and the user resource management section 330 stores this to the user information management DB 340 (step S14).

FIG. 15 is an example of the position-based traffic statistical data, where the position-based traffic data is registered for each user.

The case of the user (U1) shifting to the position (A1) again, when the position-based traffic statistics are managed for the user (U1) as described above, will be considered.

If the user (U1) shifted to the position (A1) again, the position management section 326 notifies the position information of the position (A1) to the position statistical management unit 333 (step S5). The position statistical management unit 333 refers to the traffic statistics for the position (A1) of the user (U1) based on the position-based traffic data (FIG. 15) stored in the user information management DB 340 (step S6).

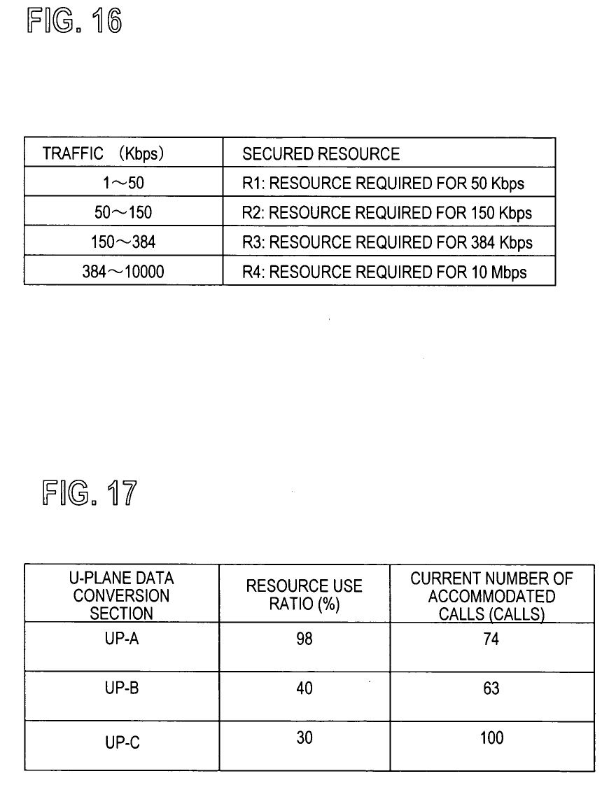

The position statistical management unit 333 determines the traffic 100 Kbps of the position (A1) from FIG. 15. FIG. 16 shows the correspondence table of the secured resource according to the traffic. In FIG. 16, R1<R2<R3<R4.

The position statistical management unit 333 notifies the band securing request of the resource R2 shown in the table in FIG. 16, according to the traffic 100 Kbps determined by referring to the traffic statistics in FIG. 15, to the U-Plane resource control section 350 (step S7).

In the U-Plane resource control section 350 which received the band securing request, the requested band control is performed to the U-Plane data conversion section 360, and the band is secured according to the position of the user (U1) if the band requested by the position statistical unit 333 is higher than the band of the user (U1) which is currently secured (step S8).

On the other hand, in the case when the requested band of the resource R2 cannot be secured because the unused resource in the U-Plane data conversion section 360 (UP-A) where the call of the user (U1) is accommodated is insufficient (in the case when the resource use rate at the current point is 98% and the number of accommodated calls is 74 in the correspondence table of the secured resource according to one traffic shown in FIG. 17), the U-Plane resource control section 350 refers to each resource use rate of a plurality of U-Plane data conversion sections 360 which are managed by the U-Plane resource control section 350 itself, and selects the U-Plane data conversion section 360 (UP-B) of which resource use ratio if 40% and the number of calls can be accommodated (63/100 calls).

The resource of R2 is secured in the U-Plane data conversion section 360 (UP-B) for the call of the user (U1), then the call of the user (U1) is shifted from the U-Plane data conversion section 360 (UP-A) to (UP-B).

[Registration of Time-Based Traffic Statistics]

If a user (U1) at a certain position (A1) places a call in the flow shown in FIG. 7, the radio network controller RNC receives the call setting request, including the subscriber information, from the remote node by the external interface (IF) section 310 (step S21).

The external interface (IF) section 310 notifies the call processing section 321 of the main control section 320 that the call setting request message was received (step S22).

The call processing section 321 which received the notice of the call setting request message performs call setting processing of the user (U1), and notifies the time statistical unit 325 that the call setting processing for the user (U1) was performed as the call setting report (step S23). At the timing of this report, the time statistical unit 325 starts time-based traffic collection from the notified time (T1: 2003/6/19 20:00), and refers to and tabulates the traffic statistical DB 370 (see FIG. 14) at every predetermined cycle (60 minute cycle is set in this example) (step S24).

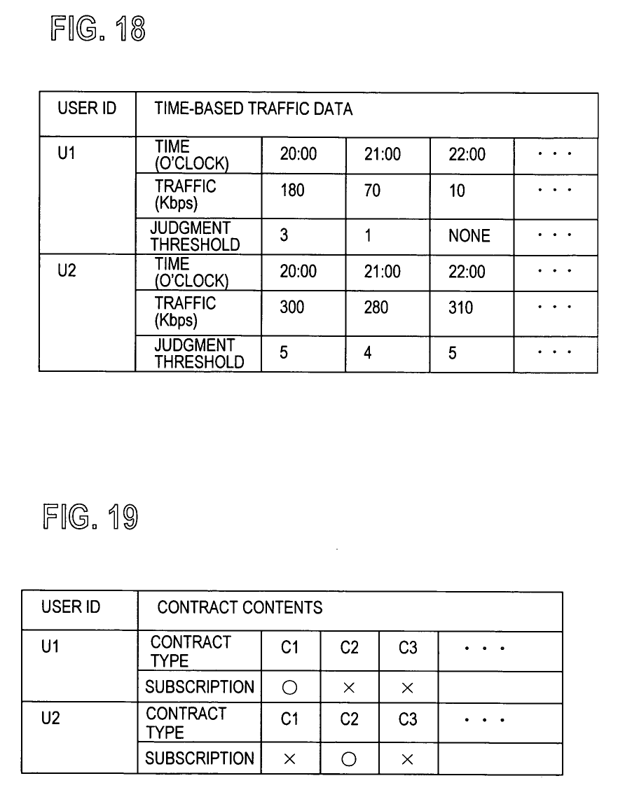

In the case of the example in FIG. 14, the time, after a predetermined cycle (60 minutes) has elapsed since the time statistical unit 325 started time-based traffic collection of the user (U1), is T4 (2003/6/19 21:00). Therefore the time statistical unit 325 tabulates the traffic statistical DB at the time in T1-T3 (60 minutes between T1: 2003/6/19 20:00 and T3: 2003/6/19 20:59) for the user (U1), and notifies the time-based traffic data (see FIG. 18), where the time zone (20:00-20:59) of T1-T3 and the average traffic (180 Kbps) are associated with the user (U1), to the user resource management section 330 (step S25), and stores it in the user information management DB 340 (step S26).

Now the case when the user connected a call at the same zone (20:00-20:59 in this case) on another day, when the time-based traffic statistics for the user (U1) are being managed as above, will be considered.

The time statistical unit 332 refers to the time-based traffic data (FIG. 18) at a predetermined cycle (step S27), and average traffic (180 Kbps) at the current time (20:00) of the user (U1) exists, so the time statistical unit 332 notifies the band securing request for the band R3 (see FIG. 16) according to this traffic to the U-Plane resource control section 350 (step S27).

If the U-Plane resource control section 350, which received the band securing request, judges that the band requested from the time statistical unit 332 is higher than the band of the user (U1) currently secured, the U-Plane resource control section 350 performs band control for the U-Plane data conversion section 360, and secures the band corresponding to the time of the user (U1) (step S29).

The band change when the user places a call and the operation when the band is insufficient in the same U-Plane data conversion section are the same as the case of the processing of registration and estimation of the position-based traffic statistics mentioned above.

[Contract Type Registration and Band Control]

When the user (U1) places a call in FIG. 8, the external IF section 310 receives the call setting request from the remote device SGSN (step S31), and the call processing section 321 receives the call setting request including the subscriber information of the user U1 notified from the external IF section 310 (step S32).

The call processing section 321 notifies the subscriber information required for band control for the user (U1) included in the call setting request to the user resource management section 330 (step S33), and stores the subscriber information of the user (U1) to the user information management DB 340 (step S34).

FIG. 19 shows an example of the subscriber information to be notified. For each user, the contract type and information on whether the user subscribes to the contract type are recorded.

The user contract information unit 331 refers to the contract type on the band securing which is required for U-Plane resource control in the subscriber information of the user (U1) in the user information management DB 340 (FIG. 19), and notifies the contract type (C1) of the user (U1) to the U-Plane resource control section 350 (step S35).

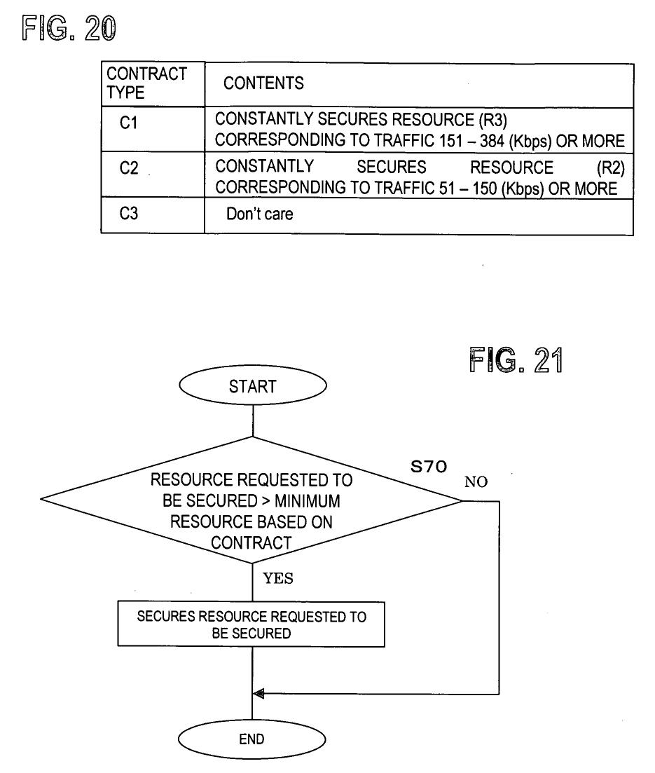

The band to be secured for each contract type of the user is set in advance, as shown in FIG. 20. In this case, the U-Plane resource control section 350, which received the contract type (C1) of the user (U1), constantly secures the resource (R3) corresponding to the traffic 151-384 (Kbps) or more (step S36).

If the call processing section 321 switches the channels of the user (U1), the call processing section 321 notifies the resource securing request according to the channel status to the U-Plane resource control section 350.

If the band control based on the contract type is being performed, priority is assigned to secure the band specified by the contract type or more. For example, FIG. 21 shows the resource control flow of the U-Plane resource control section 350 according to the contract contents. If the call processing section 321 sent the resource securing request specifying R2, the U-Plane resource control section 350 compares the size of R3 and R2 (step S70).

In this case R3>R2, so control based on a resource securing request from the call processing section 321 is not performed (step S70, NO), but resource (R3) corresponding to the traffic 151-384 (Kbps) or more is constantly secured according to the contract contents of the contract type (C1) of the user (U1).

[Band Control by Combination of Position-Based, Time-Based, and Contract Type-Based]

When band management based on position information, time information and contract type is performed using the information from the user information management DB 340 which characterizes the use status of each user (see FIGS. 6, 7 and 8), the U-Plane resource control section 350 may receive a plurality of band control requests for a user (U1) from the user resource management section 330.

When the user (U1) connects the call at the position (A1), the position statistical management unit 333 notifies the resource securing request of R2 (FIG. 16) corresponding to the traffic 100 Kbps (see FIG. 15) which is estimated at the position (A1) to the U-Plane resource control section 350, and controls the U-Plane data conversion section 360. If the time changes to 20:00 at this time, the time statistical management unit 332 may notify the resource securing request of R3 (FIG. 16) corresponding to the traffic 180 Kbps (see FIG. 18) at the time (20:00) of the user (U1) to the U-Plane resource control section 350.

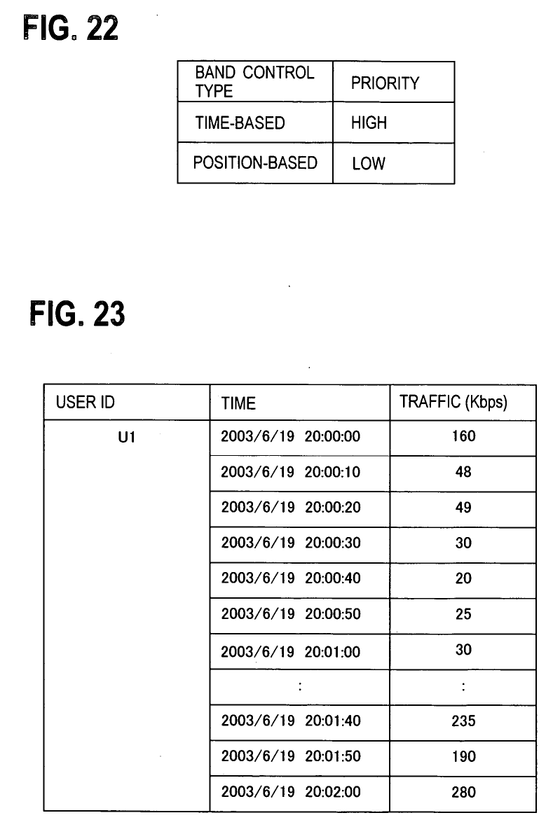

If a plurality of band securing requests are received in this way, the U-Plane resource control section 350 selects the higher one of the bands requested, and controls the band. In this case R2<R3, so the resource of R3 is secured according to the request from the time statistical management unit 332. Selection from a plurality of band securing requests may be made by assigning priority to the band control requests, as shown in FIG. 22.

[Band Release Considering Use Status of User]

Here it is assumed that the time-based traffic estimation of the user (U1) has already been performed, and the band of R3 in FIG. 16 is secured.

To secure the band of R3, the user resource management section 330 sends the resource securing request to the U-Plane resource control section 350. At this time, the judgment threshold value 3, according to the band to be secured based on the time-based traffic statistics in FIG. 18, is also notified. The judgment threshold is set in advance according to the use status of the user.

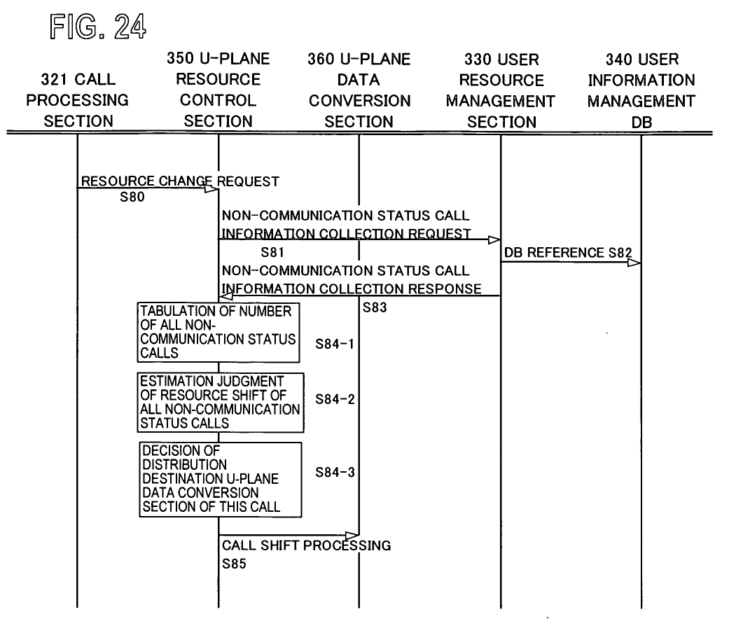

The U-Plane data conversion section 360 reports the traffic of the user shown in FIG. 23 to the U-Plane resource control section 350 at a predetermined cycle. This report is used for the U-Plane resource control section 350 as a source to judge whether a band change is necessary. If the band change judgment threshold is set in this way, the band is changed according to the judgment threshold.

In the traffic estimate for the user (U1), the band of R3 is secured, and in the case of FIG. 23, according to the traffic report of 2003/6/19 20:00:10, traffic is 48 Kbps, which requires only the band of R1.

In this case, according to the flow in FIG. 12, the U-Plane resource control section 350 increments the counter based on the judgment (step S534), and if the judgment counter exceeds the threshold (step S534, YES), the band is changed according to the traffic report (step S535).

If the judgment counter does not exceed the threshold (step S534, NO), the band is not changed. In the case of the example in FIG. 23, the user (U1) exceeds the judgment threshold 3 at 2003/6/19 20:00:40, so the U-Plane resource control section 350 changes the secured resource of the user (U1) to R1 according to 2003/6/19 20:00:40.

This example is applied to a case when the band was secured by the estimation control based on the use status of the user, but the traffic does not increase as much as the estimation, and the time of the band rechange can be adjusted by setting the judgment threshold when the band is rechanged.

In this example, the case of estimating by a time-based traffic statistics was described, but a similar judgment threshold may be set for each user in the position-based traffic statistics as well.

[Description of Non-Communication Status Calls Considering Characteristics of User]

FIG. 24 is a processing sequence when the non-communication status calls are distributed. The case when the U-Plane resource control section 350 received the resource change request to a non-communication status call for the call of the user (U1) at 20:00-20:59 will be described.

When the call processing section 321 sends a resource change request to the U-Plane resource control section 350 (step S80), the U-Plane resource control section 350 inquires about time-based traffic requests for the user of all the non-communication calls (including the user (U1)) at 20:00-20:59 of each U-Plane data conversion section 360 to the user resource management section 330 (step S81).

The user resource management section 330 refers to the traffic data of the user information management DB 340 (step S82), and notifies the estimated traffic in 20:00-20:59 of all the non-communication status users to the U-Plane resource management section 350 (step S83).

By this, the U-Plane resource management section 350 can tabulate the non-communication status calls (step S84-1), judges the estimation of the resource change of all the non-communication status calls (step S84-2), decides the U-Plane data conversion section to be the distribution destination (step S84-3), and can acquire the estimated traffic.

Therefore call shift processing according to the traffic estimation of the non-communication status calls is performed (step S85), and non-communication status calls can be distributed.

Here in the non-communication status call distribution example, it is assumed that the threshold is at 150 Kbps, and the case when the estimated traffic for all the non-communication status calls is higher than the threshold is set as (A), and the case when lower is set as (B), and in each U-Plane, non-communication status calls are equally distributed by managing the calls in each (A) and (B) status.

In the case of the example in FIG. 18, the estimated traffic of the user (U1) is 180 Kbps, so the U-Plane resource management section 350 judges that the call status is (A).

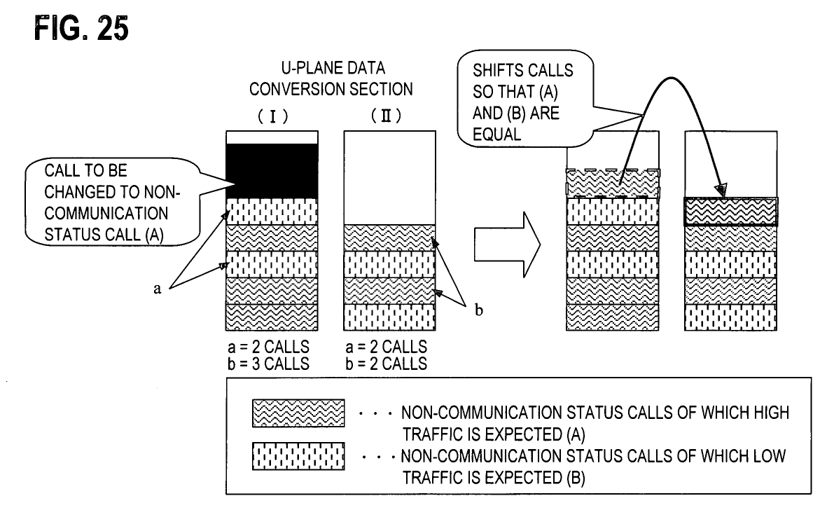

In the case of FIG. 25, on the other hand, if the calls of the user (U1) shifted to the non-communication status calls (A) in the U-Plane data conversion section (I), the number of non-communication status calls in status (A) is 4 in the U-Plane data conversion section (I), and 2 in the U-Plane data conversion section (II). Therefore the number of calls to be accommodated in each U-Plane data conversion section 360 is not equal.

In this case, in order to equalize the calls in status (A), the calls of the user (U1) are shifted to the U-Plane data conversion section (II), and the number of calls in status (A) is equalized in U-Plane conversion section (I) and (II) respectively.

When the non-communication status calls after change are judged in status (B) as well, the calls are shifted so that the number of non-communication status calls in status (B) in each U-Plane data conversion section 360 become equal.

In this way, equal distribution of the non-communication status calls can be performed considering the increase/decrease of the traffic of each user.

In the present example, the characteristics of the user are judged by the estimated traffic based on the time-based traffic statistics, and non-communication status calls are distributed, but distribution may be judged based on the data characterizing the user.

In this way, by this invention, band management according to the contract type and the use status of each user becomes possible for the bands managed in the radio network controller. Conventionally the highest band may not be secured due to insufficient resources by the radical traffic change, such as the case of a shift from non-communication status (PCH) to HS-DSCH status, but in the present invention, securing a band according to the channel type and distribution to another U-Plane data conversion section are possible for each cell, by storing the characteristics of the users.

The present invention described W-CDMA, but application of the present invention is not limited to this but can be applied in the same way for the band control in other radio blocks.

Therefore the band management method in the radio network controller to which the present invention is applied has the following effects.

First, in the present invention, information on the characteristics of each user, such as the use format and traffic use status, can be stored. Using this information, a band can be secured in advance considering the characteristics of each user, and communication can be possible after a channel is switched, without generating a delay in data transfer by users.

The second effect is by equally distributing calls to a plurality of U-Plane data conversion sections using the present invention, the number of users restricted by the cluster of calls to a part of the U-Plane data conversion sections can be prevented. Even if a band is insufficient in one U-Plane data conversion section, a band can be secured for a call by distributing the call to another U-Plane data conversion section, and an entire band can be effectively used.

In the case of a businessman, for example, data transmitted/received by a personal use terminal increases in such time zones as break time and after work. Places where the data volume is high may be homes and station platforms during commuting. If patterning is possible for each user like this, an optimum band for the user can be secured in advance according to the use format. Combination with contract type is also possible.

### INDUSTRIAL APPLICABILITY

As the highest band expands by the release of HSDPA in the future, an increase in the number of users and increase in non-communication status calls due to a new service format, such as constant connection, are expected, and the present invention can implement effective use of bands considering the characteristics of the use format of the user, instead of solving the above problem by physical expansion of the device.

1. A radio network controller disposed on a network, comprising:
a user resource management section managing information, which characterizes a user connected to the radio network controller;
a plurality of user signal data conversion sections, each performing conversion processing of user signal data; and
a resource control section performing resource control for securing a band for the plurality of user signal data conversion sections, and securing a band appropriate for the characteristics of the user.

2. The radio network controller according to claim 1, further comprising:
a traffic statistical section performing traffic collection for extracting characteristics of each user; and
a user information management data base storing the characteristics of each user collected by the traffic statistical section according to the control of the user resource management section, and wherein
the user resource management section requests the resource control section to secure bands corresponding to the characteristics of each user stored in the user information management data base.

3. The radio network controller according to claim 2, wherein
the traffic statistical section further includes a position statistical unit tabulating a position-based traffic statistics of each user, and stores the position-based traffic statistics for each user tabulated by the position statistical unit, in the user information management data base, and
the user resource management section secures bands by requesting the resource control section to secure bands according to the tabulated position-based traffic for each user, stored in the user information management data base.

4. The radio network controller according to claim 2, wherein
the traffic statistical section further includes a time statistical unit for tabulating time-based traffic statistics of each user, and stores the time-based traffic statistics of each user tabulated by the time statistical unit, in the user information management data base, and
the user resource management section secures bands appropriate for the tabulated time-based traffic for each user, stored in the user information management data base.

5. The radio network controller according to claim 1, wherein the user resource management section calculates a required band according to the use status of each user stored in the user information management data base, and requests the resource control section to secure the calculated required band.

6. The radio network controller according to claim 5, wherein when the control of securing a band requested from the user resource management section to the resource control section is performed, if a corresponding user signal data conversion section cannot secure a band, control is performed such that another user signal data conversion section secures the band.

7. The radio network controller according to claim 5, wherein
a judgment count threshold is attached to a band securing request from the user resource management section to the resource control section, and
the resource control section receives a traffic report from the user signal data conversion section at a predetermined cycle, compares a band which can maintain the current traffic and a band which is currently secured each time a traffic report is received, and performs control to change the band which is currently secured to the band which can maintain the current traffic when the number of successive judgments that the band which can maintain the current traffic is smaller is the judgment count threshold or more as the comparison result.

8. The radio network controller according to claim 1, wherein
when the user shifts to non-communication status, the resource control section performs control such that the non-communication status calls are distributed to the plurality of user signal data conversion sections so that the number of calls become equal, based on the use status of the non-communication status users accommodated in all of the plurality of user signal data conversion sections.

9. The radio network controller according to claim 1, wherein
the user resource management section further includes position statistical management unit, and estimates the increase/decrease of [position-based traffic] from the position-based traffic of each user stored in the user information management data base, and
the resource control section performs control such that the band according to the traffic of shift destination of the user is secured in the user signal data conversion section.

10. The radio network controller according to claim 1, wherein
the user resource management section further includes time statistical management unit, and estimates the increase/decrease of [time-based traffic] from the time-based traffic of each user stored in the user information management data base, and
the resource control section performs control such that the band according to the time-based traffic of each user is secured in the user signal data conversion section.

11. The radio network controller according to claim 1, wherein
the user resource management section further includes user contract information management unit, and estimates a required band according to the contract contents of each user stored in the user information management data base, and
the resource control section performs control such that the required band according to the contract contents of each user is secured in the user signal data conversion section.
